(19) United States
(12) Patent Application Publication
(10) Pub. No.: US 2015/0069845 A1
(43) Pub. Date: Mar. 12, 2015

(54) ELECTRIC DEVICE AND METHOD FOR CONTROLLING AN ELECTRIC ENERGY GENERATOR

(71) Applicant: Manfred Liebel, Burgthann (DE)

(72) Inventor: Manfred Liebel, Burgthann (DE)

(73) Assignee: SIEMENS AKTIENGESELLSCHAFT, Muenchen (DE)

(21) Appl. No.: 14/391,282

(22) PCT Filed: Apr. 11, 2012
(86) PCT No.: PCT/EP2012/056549

§ 371 Date: Oct. 8, 2014

(51) Int. Cl. H02J 3/38

(52) U.S. Cl. CPC H02J 3/38
USPC 307/80

(57) ABSTRACT

An electric device for controlling an energy generator connected to an energy supply grid includes a control device that controls the generator with respect to the energy generator operating state. The electric device, which is connected between the energy supply grid and the generator, enables comparably simple control of the generator. The control device monitors the voltage and/or frequency and generates a switch-on signal if the voltage and/or frequency falls below a lower threshold and generates a switch-off signal if the monitored voltage and/or frequency exceeds an upper threshold. If a switch-on signal is present, the energy generator is switched on or the electric power output is increased. If a switch-off signal is present, the energy generator is switched off or the electric power output is decreased. A related method provides for controlling an electric energy generator.

The invention relates to an electric device for controlling an energy generator which is connected to an electric medium-voltage or low-voltage energy supply grid comprising a control device via which the energy generator can be controlled with respect to its operating state. The invention also relates to a method for operating an electric medium-voltage or low-voltage energy supply grid with at least one energy generator connected to the medium-voltage or low-voltage energy supply grid which is designed to supply electric power into the medium-voltage or low-voltage energy supply grid.

Existing electric energy supply grids are in principle designed to supply electric energy from a few central energy generators, for example coal-fired power plants, to the end users. The transmission direction of energy distribution systems of this kind is substantially constant; in addition, the energy generation is adapted to the—forecast and/or actual—energy demand by the end users. Recent endeavors and political targets have resulted in a liberalization of the electric energy market. The result of this is that for several years there has been an intensification of the supply of electric energy from decentralized energy generators, such as, for example, wind farms, small block-type thermal power plants, biogas plants and photovoltaic plants, to medium- or low-voltage grids and this has led to an upheaval in the previously usual transmission directions.

Decentralized energy generators, which provide electric energy from regenerative sources, such as wind or sunlight, are also characterized by extreme fluctuations with respect to the amount of electric energy supplied therefrom; for example, when the wind is strong, a wind farm can output a comparatively large amount of electric power into the energy supply grid, while, when the wind is weak or there is even no wind, the electric power supplied can drop to zero.

In the past, this problem was, for example, countered by the provision of so-called peak-load power plants, which are put into operation at times of low decentralized feed-in or particularly high energy withdrawal by consumers. However, the provision and operation of peak-load power plants of this kind, which are only needed comparatively rarely, are associated with high costs. A further possibility for leveling the irregular provision of electric energy by the energy supply grid due to a volatile energy feed-in consists in the operation of energy stores, wherein in particular so-called pumped storage plants are used. When there is a surplus of electric energy in the energy supply grid, the storage capacities are charged, for example by the operation of a pumped storage plant during pumping, while, when there is a shortage of electric energy in the energy supply grid, the capacities of the energy store are discharged, for example by the operation of the pumped storage plant as a hydroelectric power plant. However, due to special environmental requirements (two adjacent different height levels), it is not possible to use pumped storage plants of this kind in all locations; other kinds of energy stores, for example batteries, are still comparatively expensive.

Therefore, the intensified use of decentralized energy sources for supplying energy requires new control concepts relating to the distribution of electric energy at both high- and medium-voltage level and at low-voltage level right to the end user of the electric energy. Control concepts of this kind have recently been frequently summarized under the name “smart grid”. One object of smart grid concepts of this kind is efficient control of the supply and demand of electric energy in the energy supply grid so that, for example, fewer peak-load power plants have to be provided.

In this context, a method is known from international patent application WO 2008/148417 A1 with which electric energy generators are controlled by the transmission of control signals from a central grid control device via communication links to a plurality of energy generators connected to an energy supply grid. This method requires communication means parallel to the actual supply grid in order to be able to transmit the control signals between the grid control device and the energy generators.

The invention is based on the object of developing an electric device and a method of the type described in the introduction such that it is possible to control an electric energy generator in a comparatively simple manner.

According to the invention, this object is achieved by an electric device of the type mentioned in the introduction which is arranged in the region of the connection point between the medium-voltage or low-voltage energy supply grid and the energy generator; the control device of the electric device comprises a monitoring device, which is designed to monitor the voltage and/or frequency applied to the electric device on the grid side and to generate a switch-on signal if the monitored voltage and/or frequency falls below a lower threshold and to generate a switch-off signal if the monitored voltage and/or frequency exceeds an upper threshold. The control device is designed to switch on the energy generator or to increase the electric power output by the energy generator to the medium-voltage or low-voltage energy supply grid if a switch-on signal is present and to switch off the energy generator or decrease the electric power output by the energy generator to the medium-voltage or low-voltage energy supply grid if a switch-off signal is present.

The invention utilizes the knowledge that, depending upon the load on the grid and energy supply, the voltage and/or the frequency (hereinafter also referred to individually or together as “grid parameters”) of the electric energy supply grid fluctuate about a nominal value. If there is a surplus of electric energy, a voltage or frequency higher than the nominal value is identified, while, when there is a shortage of electric energy, the voltage or frequency sinks compared to the nominal value. This enables the electric device to control the energy generator solely on the basis of local measurements in the region of the energy generator.

A particular advantage of the electric device according to the invention also consists in that fact that no communication link with a higher-ranking control, for example an energy management system, is required in the energy supply grid to control the energy generator, since the control behavior is derived directly from the monitored network parameters in the region of the energy generator. Consequently, the invention discloses an electric device that recognizes independently and autonomously when there is a surplus of energy and when there is a shortage of energy in the energy supply grid and adapts the feed-in of electric energy from the energy generator accordingly. Dispensing with communication links also makes the electric device less susceptible to so-called cyber attacks with which hackers infiltrate a communication system in order to manipulate the operation of the energy generator associated therewith, for example such that, in the case of a shortage of energy, all energy generators are switched off in order in this way to cause a destabilization of the energy supply grid. Energy generators for the purposes of the invention are in particular considered to be decentralized small- and medium-power energy generators and, for example photovoltaic plants, small hydroelectric power plants, mini and micro block-type thermal power plants, wind farms, biogas plants and fuel cell plants.

An advantageous development of the electric device according to the invention provides that, in the case of an energy generator comprising an energy store, the control device is designed, if a switch-off signal is present, to decrease the electric power output by the energy generator to the medium-voltage or low-voltage energy supply grid in that the electric energy generated by the energy generator or the primary energy used by the energy generator to generate the electric energy is wholly or partially diverted into the energy store.

This can have the result that the energy generator does not have to be expensively switched off or throttled so that the operation of the energy generator can be continued as uniformly, and hence as efficiently, as possible. In particular, during the operation of regenerative energy generators, this enables the energy provided by the regenerative energy source to be used independently of the respective state of the electric energy supply grid. Energy generators with an inherent energy store for primary energy are for example hydroelectric or biogas plants; it is also possible for each energy generator to be provided with separate energy stores, for example in the form of batteries, in which the electric energy generated is stored temporarily.

According to an advantageous embodiment, it can also be provided in this context that the control device is designed, if a switch-on signal is present, to increase the electric power output by the energy generator to the medium-voltage or low-voltage energy supply grid in that the electric energy stored in the energy store is wholly or partially output to the medium-voltage or low-voltage energy supply grid or the stored primary energy in the energy store is wholly or partially used to generate electric energy.

This embodiment has the advantage that the electric energy generated in the energy supply grid during a surplus of energy can be fed back into energy supply grid at a later time or the stored primary energy can be used to generate electric energy at a later time. In addition, operators of energy generators are able to maximize their feed-in remuneration since the energy generator does not have to be switched off and, in addition to the electric energy currently being generated, it is also possible to feed in the previously stored energy.

A further advantageous embodiment of the electric device according to the invention provides that the control device comprises a delay element, which is designed such that, if a switch-on signal is present, it delays the switching-on of the energy generator or the increasing of the power output by the energy generator by a time delay specified by means of a random generator and, if a switch-off signal is present, it delays the switching-off of the energy generator or the decreasing of the power output by the energy generator by a time delay specified by means of a random generator.

The result of this is that, even when a plurality of electric energy generators are switched on or off in the case of an increase in the voltage of frequency above the upper threshold and/or in the case of a drop in the voltage of frequency below the lower threshold, no unwanted power peaks or drops occur, which could in turn themselves lead to a shift of voltage or frequency in the energy supply grid. To this end, the delay element comprises a random generator, which determines a random time delay in response to the switch-on or switch-off signal by which the control of the electric energy generator is delayed. This ensures that a plurality of energy generators controlled by the same type of electric devices change their feed-in, not simultaneously, but gradually, so that the operating state of the energy supply grid does not change abruptly, but gradually.

In this context, it can be specifically provided that the random generator is designed to output the time delay directly.

In this case, the random generator directly determines a value for the time delay by which the delay element delays the control of the energy generator.

In this context, it can also be provided that the random generator for determining the time delay is designed such that the more the value of the monitored voltage and/or frequency exceeds the upper threshold or falls below the lower threshold, the shorter the time delay.

This matching of the mode of operation of the random generator to the value of the monitored grid parameters can advantageously result in the individual electric energy generators being controlled more quickly when the threshold values are exceeded or fallen below to a greater degree. This is of advantage because, for example, higher values of the monitored grid parameters are indicative of correspondingly higher energy surpluses which are retained in the electric energy supply grid and that the energy generator has to be controlled more quickly to compensate the surplus.

Alternatively to the direct specification of a time delay, it can also be provided that the random generator is designed to output a random signal with at least two states, wherein, when a selected state of the random signal is present, the time-delay process is terminated, while if the selected state is absent, the time-delay process is continued and the random signal is generated again—after a time interval.

This enables the random generator to have a comparatively simple design since, in the simplest case, it has to generate a random signal with only two states.

In this context, it can be specifically provided that the random generator is designed to increase the probability with which the random signal adopts the selected state the further the value of the monitored voltage and/or frequency exceeds the upper threshold or falls below the lower threshold.

To this end, according to a further advantageous embodiment, it can, for example, be provided that the random generator is designed such that the more the value of the monitored voltage and/or frequency exceeds the upper threshold or falls below the lower threshold, the shorter the time interval between two sequential outputs of the random signal.

A further advantageous embodiment of the electric device according to the invention provides that the delay element is designed to cancel the time-delay process if the monitored voltage and/or frequency falls below the upper threshold or exceeds the lower threshold during the time delay.

This enables the control of further electric energy generators, which, due to the length of the time delay provided therefor, have not yet been controlled, to be cancelled if there is no longer any surplus or shortage of electric energy in the energy supply grid. Consequently further electric energy generators are only controlled by their corresponding electric devices for as long as a corresponding voltage or frequency deviation indicates a surplus or shortage of energy.

A further advantageous embodiment of the electric device according to the invention provides that the electric device is assigned a priority class in dependence on the type of the energy generator and information on the priority class is stored in a storage device of the electric device. In this case, the energy generator is only controlled by the electric device if the information on the priority class conforms to a priority level determined by the control device in dependence on the degree to which the value of the monitored voltage and/or frequency exceeds the upper threshold or falls below the lower threshold.

In this way, individual bands are so-to-speak established in the region around the nominal values for voltage and/or frequency to which different priory levels are assigned. If the voltage and/or frequency are within such a band, only those energy generators with a priority class conforming to the priority level in question are controlled.

For example, priority classes or levels can be established for the switching-off of energy generators as follows; obviously, the individual assignment of priority classes or levels using similar or different criteria is possible:

Priority class/level 1:
grid parameters are within the region close to the nominal value with a positive deviation;
when permissible, (for example where permitted by the local demand for heat), energy generators fed from fossil energy sources and the operation of which is associated with CO₂ emissions (for example mini and micro block-type thermal power plants) are switched off.

Priority class/level 2:
grid parameters are within the region close to the nominal value with a positive deviation (deviation greater than or equal to priority class/level 1);
energy generators with energy stores are operated in storage mode

Priority class/level 3:
grid parameters are within the region remote from the nominal value with a positive deviation (deviation greater than priority class/level 2);
all energy generators that have not yet been switched off of priority classes 1 and 2 are switched off immediately or operated in storage mode.

Priority class/level 4:
grid parameters are within the region remote from the nominal value with a positive deviation (deviation greater than or equal to priority class/level 3);
energy generators with part-load capability are operated in part-load mode.

Priority class/level 5:
grid parameters are within the region remote from the nominal value with a positive deviation;
all other energy generators remaining in the grid are switched off.

When energy generators are switched on in the event of an energy shortage, the priority classes or levels can be specified in a similar or corresponding way.

Particularly in the case of plants with limited storage capacity, such as is the case for example with small hydroelectric power plants or biogas plants, optimum usage is made of the storage capacity. In addition, a plurality of different energy generators can be operated with preference being given to regenerative energy generators with the lowest possible level of CO₂ emissions.

With respect to the method, the above-named object is achieved by a method of the type described in the introduction, with which the grid-side voltage and/or frequency present at the connection point between the energy generator and the medium-voltage or low-voltage energy supply grid is monitored by means of an electric device. The energy generator is switched on or the electric power output by the energy generator to the medium-voltage or low-voltage energy supply grid is increased if the monitored voltage and/or frequency falls below a lower threshold, and the energy generator is switched off or the electric power output by the energy generator to the medium-voltage or low-voltage energy supply grid is decreased if the monitored voltage and/or frequency exceeds an upper threshold.

With respect to the advantages of the method according to the invention, reference is made to the statements made above relating to the electric device.

The invention will now explained be explained in more detail with respect to exemplary embodiments. To this end, the drawings show:

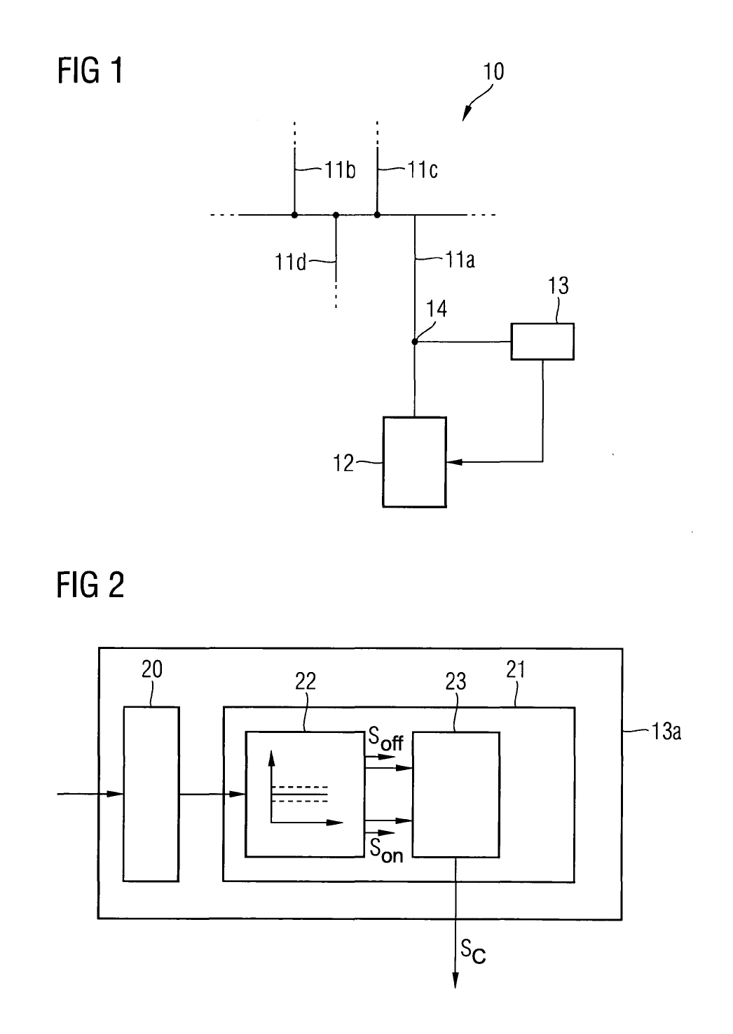

FIG. 1 a schematic block diagram of an electric medium- or low-voltage energy supply grid with a controllable energy generator;

FIG. 2 a schematic block diagram of a first exemplary embodiment of an electric device for controlling an energy generator;

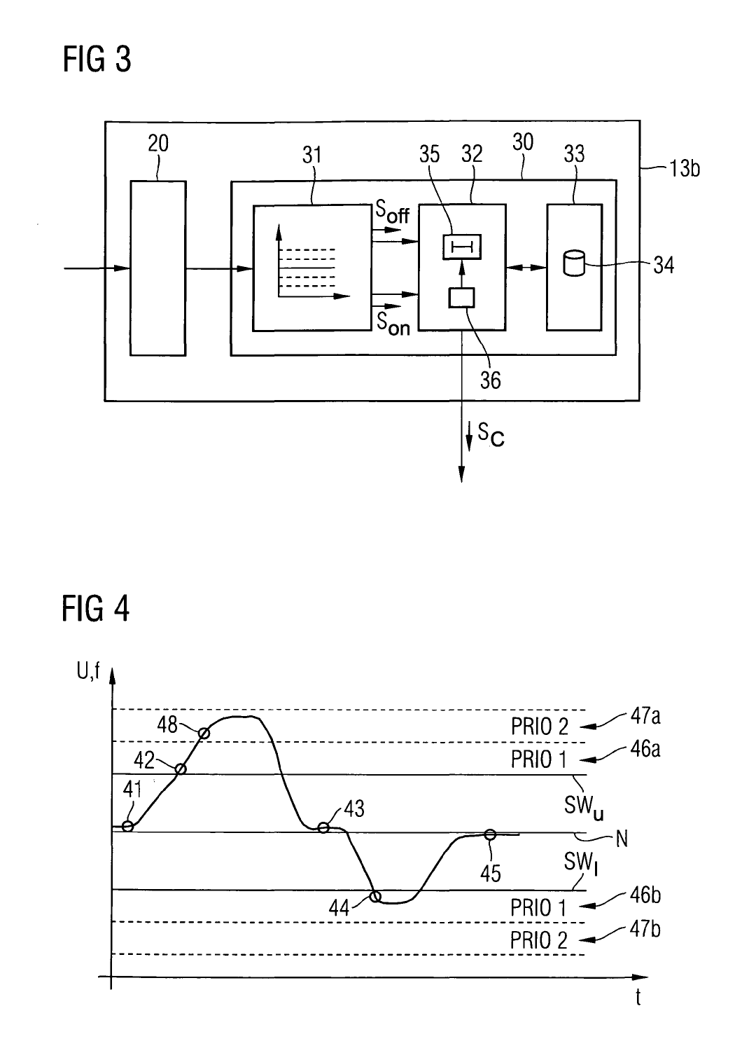

FIG. 3 a schematic block diagram of a second exemplary embodiment of an electric device for controlling an energy generator; and

FIG. 4 a diagram to explain the mode of operation of the control of an energy generator.

FIG. 1 is an extremely schematic representation of a section of an electric energy supply grid 10, which can be an electric medium-voltage grid or an electric low-voltage grid. The section of the electric energy supply grid 10 has branches 11a, 11b, 11c and 11d, of which in FIG. 1, for purposes of clarity, only branch 11a is shown in more detail. An energy generator 12 is connected to branch 11a in a suitable way,—for example by means of a transformer and/or a converter—although this is not shown in more detail in FIG. 1. Further electric energy generators can be connected to the other branches 11b to 11d. In addition, however, other (not shown) electric energy consumers can be connected to the energy supply grid 10.

The electric energy generator 12 can, for example, be a small decentralized generator; in particular, the energy generator can be a photovoltaic plant, a small hydroelectric power plant, a mini or micro block-type thermal power plant, a wind farm, a biogas plant or a fuel-cell plant. Since the liberalization of the power market, small and medium-power decentralized energy generators of this kind have been increasingly used in medium-voltage and low-voltage levels of electric energy supply grids and now make a significant contribution to the provision of electric energy to power supply grids. However, while large electricity generators, such as, for example, large power plants in the energy supply grid are integrated in complex control mechanisms for controlling energy supply and demand, to date small electricity generators are usually not covered, or only covered to a very restricted extent by control mechanisms of this kind. Therefore, there is a requirement also to incorporate electric energy generators of this kind in a grid control system in the simplest way possible.

Therefore, in order to control the electric energy generator 12, in each case in dependence on the respective load situation in the electric energy supply grid 10, an electric device 13 is provided which is designed to influence the operational status of the electric energy generator 12. The electric device 13 shown in FIG. 1 only by way of example as a separate device shown can also be an integral component of the actual electric energy generator 12.

The electric device 13 can generally be used to switch the electric energy generator 12 on or off; it can also be operated at full load or—if possible—at part load. If the electric energy generator 12 has a storage means, this means can also be integrated in the control of the operating status in that, for example, the energy generator 12 diverts the electric power it has generated partially or entirely into an electric energy store or supplies the electric energy stored in the electric energy store for a period of time back to the energy supply grid 10. It is also possible in the case of energy generators with an inherent storage means for primary energy, from which the electric energy is generated, for the actual primary energy to be stored and used at a later time to generate the electric energy. Energy generators with inherent energy stores are, for example, hydroelectric plants, with which an upstream water reservoir can be replenished or a biogas plant with which the biogas to be burned to generate the electric energy is stored temporarily in a gas tank.

In this case, the electric energy generator 12 is controlled by the electric device 13 in dependence on the state of the electric energy supply grid 10 prevailing in the region of the electric energy generator 12. The mode of operation when the electric energy generator 12 is controlled by the electric device 13 will be explained below with reference to FIG. 2, which shows a first exemplary embodiment of an electric device 13a. In the following statements—which also apply to FIGS. 3 and 4—frequent references are made to individual components (for example monitoring device, command device). These components can represent both separate structural units within the electric device and also be embodied as components, for example programming modules, of a device's software.

To evaluate the electric energy supply grid 10, measuring signals are recorded at a measuring point 14 located in the region of the electric energy generator 12 (that is, for example, at a connection point at which the electric energy generator 12 is coupled to branch 11a of the energy supply grid 10, but at least on the same branch 11a on which the energy generator 12 is arranged) by means of suitable sensors from which a voltage (for example an effective voltage) and/or a frequency of the voltage signal in the individual phases of the energy supply grid 10 can be derived. Hereinafter, voltage and/or frequency are also referred to individually or together as grid parameters. The measuring signals recorded are sent to the electric device 13 and initially preprocessed in a measured value acquisition device 20 (see FIG. 2). The preprocessing in the measured value acquisition device 20 can comprise, for example, an analog-digital conversion of the measuring signals, filtering and finally the determination of the grid parameters required in a way that is known per se. The grid parameters determined from the measuring signals are provided at the output side by the measured value acquisition device 20 to a control device 21 of the electric device 13a.

The control device 21 comprises a monitoring device 22, which is designed to monitor the grid parameters determined. The monitored grid parameters can namely be used to draw conclusions regarding the respective operating situation of the electric energy supply grid. The values of voltage or frequency usually correspond to a nominal value but can fluctuate about this nominal value within a narrow tolerance band. If the monitored voltage or frequency is in the upper region of the tolerance band (i.e. above the nominal value), there is a surplus of electric energy in the energy supply grid. Correspondingly, if the values of the monitored grid parameters are in the lower region of the tolerance band (i.e. below the nominal value), it may be concluded that there is a shortage of electric energy in the energy supply grid.

Since the measured values from which the grid parameters voltage and/or frequency are derived are recorded in the local region of the actual energy generator 12, the monitoring device 22 is able to determine a local operating state of the energy supply grid 10 in the vicinity of the energy generator 12. This is of advantage, since the electric device 13 is able—where possible and necessary—to control the electric energy generator 12 in response to the recognized operating state in order to balance the local operating state of the energy supply grid 10.

The electric device 13a utilizes the dependence of the grid parameters on the load situation or the operating state of the electric energy supply grid 10 in that, if the values of the monitored voltage or frequency are above the upper threshold, the monitoring device 22 sends a switch-off signal S_{off} to a command device 23 of the control device which prompts the latter to send a command signal S_{c} to the electric energy generator 12. In this case, the control signal causes the electric energy generator 12 to be switched off or the electric power fed by the electric energy generator 12 into the energy supply grid 10 to be reduced. Correspondingly, in the case of a shortage of energy in the energy supply grid recognized from the dropping of the grid parameter observed below a lower threshold, the monitoring device generates a switch-on signal Sₒₙ, which causes the command device 23 to send a control signal to the energy generator 12 thus effecting a switching-on of the energy generator 12 or an increase in the electric power output thereby to the energy supply grid. This is illustrated with reference to FIG. 4. FIG. 4 is a diagram in which the time curve of a grid parameter (voltage and/or frequency) is plotted. A straight line N shows the nominal value of the corresponding grid parameter. The upper and lower tolerance bands are bounded by corresponding thresholds SWᵤ and SW₁. At a measuring point 41, the grid parameter observed has a value close to the nominal value. This means that there is a balanced ratio of feed-in to withdrawal of electric energy at the measuring point 14 at which the measuring signals on which the network parameters determined are recorded.

If the ratio of feed-in to withdrawal in the electric energy supply grid in the region of the measuring point 14 shifts in favor of energy feed-in, the grid parameter curve rises as shown in the depiction in FIG. 4 until the exceeding of the upper threshold SWᵤ is determined at a measuring point 42. The exceeding of the upper threshold SWᵤ means that there is now a surplus of electric energy in the energy supply grid 10 in the region of the measuring point 14. As explained above, the monitoring device 22 therefore sends a switch-off signal S_{off} to the command device 23 of the control device 21. Thereupon, the control device 21 influences the energy generator 12 via the control signal S_{c} so that it reduces the electric power fed in or switches the feed-in off completely. To this end, if possible, the electric energy generator 12 can be run in part-load mode or, if a storage means is available, the electric energy generated can be wholly or partially diverted into an electric energy store or the primary energy used to generate the electric energy can be stored temporarily.

Due to the subsequent reduction of the feed-in of electric energy in the region of the measuring point 14, another change in the observed grid parameter is noted; the curve moves back in the direction of the nominal value and indicates, for example at measuring point 43, a balanced load state of the electric energy supply grid.

If, at a later time, the load state of the energy supply grid in the region of the measuring point 14 shifts in favor of energy withdrawal, for example due to the connection of further energy consumers—as shown in FIG. 4—the curve of the observed grid parameter sinks until it falls below the lower threshold SW₁ at point 44. The monitoring device 22 recognizes that this value has been fallen below and then sends switch-on signal Sₒₙ to the command device 23. This generates a corresponding control signal S_{c} prompting the energy generator to increase the electric power fed into the energy supply grid. This can, for example, take place by a complete (re-)switching-on or by an increase in an operating status within the part-load operation up to full-load operation. If the energy generator has a storage apparatus, alternatively or additionally to the feed-in from the current energy generation, it is also possible for the electric energy stored in the energy store to be fed into the energy supply grid or the stored primary energy used for—possibly intensified—generation of electric energy. This measure enables the energy supply grid to be returned to a balanced state, such as is indicated, for example, at measuring point 45 in FIG. 4.

The described mode of operation of the electric device can have the result, on the one hand, that, in the case of a surplus of electric energy in the electric energy supply grid, the electric energy generator reduces its fed-in power or completely stops the feed-in and, on the other, in the case of a shortage of electric energy in the electric energy supply grid, correspondingly increases or (re)starts the feed-in.

A particular advantage of the electric device consists in the fact that no communication link with a higher-ranking device in the electric energy supply grid is necessary to determine the corresponding control signal for the electric energy generator and it is possible to respond directly to local changes to the load situation in the electric energy supply grid.

Finally, FIG. 3 shows a further exemplary embodiment of an electric device 13b. The principle mode of operation of the electric device 13b according to FIG. 3 conforms to the mode of operation already explained with respect to FIGS. 1 and 2 so that the description of FIG. 3 in particular emphasizes the differences. Like the electric device 13a according to FIG. 2, the electric device 13b also comprises a measured value acquisition device 20 and a control device 30. Like the control device 21 of the electric device 13a according to FIG. 2, the control device 30 is in principle designed to control the connected electric energy generator according to the local load situation in the electric energy supply grid 10 with reference to the detected grid parameters, voltage and/or frequency. As already explained with respect to FIG. 2, with the electric device 13b, the control is performed such that, in the event of a surplus of electric power in the energy supply grid, the electric energy generator reduces the fed-in power, while, in the case of a shortage of electric energy in the energy supply grid 10, the energy generator 12 is prompted to increase the electric power fed into the energy supply grid 10.

The control device 30 according to FIG. 3 comprises a monitoring device 31, a command device 32 and a storage device 33. Information 34 on the priority class of the electric energy generator 12 assigned to the electric device 13b can be stored in the storage device 33. The priority class can be used to determine the specific load state of the energy supply grid at which the respective energy generator is to be controlled. Priority classes can, for example, be defined as already described above.

In order to be able to carry out differentiated control of a plurality of energy generators with different priority classes according to the respective load situation in the electric energy supply grid, the region of the corresponding grid parameter around the nominal value N (see FIG. 4) can also be divided into different priority levels. Here, the lowest priority level is delimited by the respective threshold SWᵤ or SW₁ on the side facing the nominal value N. In FIG. 4, there are two different priority levels above and below the nominal value, namely a priority level 1 (reference numbers 46a and 46b) as a tolerance band comparatively close to the nominal value and a priority level 2 (reference numbers 47a and 47b) as a tolerance band comparatively remote from the nominal value. In the exemplary embodiment according to FIG. 4, the tolerance band immediately surrounding the nominal value is not assigned a priority level since a fluctuation of the grid parameters within this tolerance band should not have any impact on the control of the electric energy generator; in deviation from this, it is obviously possible to assign a priority level in this region at any time. It is obviously also possible to adapt and configure the priority levels in different types and numbers according to the respective requirements of the grid operator or the operator of the electric energy generator.

The information 34 on the priority class stored in the electric device 13b in the storage device 33 classifies the energy generator connected to the electric device 13b as an energy generator of priority class 2. If, now, for example with an energy generator of priority class 2, the curve of the monitored grid parameter in FIG. 4 reaches the measuring point 42 above the upper threshold SWᵤ, despite the threshold violation, this has no impact on the control of the energy generator connected to the electric device 13b since the measuring point 42 is within priority level 1, while the energy generator is assigned priority level 2.

Consequently, the monitoring device 31, on the one hand, registers the exceeding of the upper threshold and, on the other, determines the precise priority level of the exceeding and supplies this information to the command device 32. The command device 32 compares the priority level of the threshold violation with the information 34 on the priority class of the energy generator stored in the storage device 33 and then in the case of the presence of a switch-off signal S_{off}—indicating the mere existence of a threshold violation—only generates a corresponding control signal S_{c}, if the priority class read out corresponds to the priority level of the threshold violation. Since the measuring point 42 lies within the region of priority level 1 and the information 34 on the priority class of the energy generator indicates priority level 2, the command device 32 does not initiate any control action for the connected energy generator at the time of the measuring point 42.

If—as shown in FIG. 4—the curve continues to rise and reaches priority level 2, as indicated by a measuring point 48, the monitoring device 31 informs the command device 31 of the persisting threshold violation of the upper threshold SW, on the one hand and of the changed priority level (now priority level 2) on the other. The comparison with the stored information 34 on the priority class of the connected energy generator carried out by the command device 32 now produces a match so that the command device 32 correspondingly issues a control signal S_{c} for the energy generator, which prompts the latter to reduce the electric power stored in the electric energy supply grid.

The provision of priority levels and priority classes for different types of energy suppliers advantageously enables differentiated consideration to be paid the possibility of the respective energy generator changing its feed-in situation in the short term. In addition, it is also possible to use further criteria, for example CO₂ emissions, of the respective energy generator to form a priority list for the operational use of the individual energy generators.

The command device 32 of the electric device 13b can also have a delay element 35, which—optionally taking into account the respective priority level or class—delays the forwarding of the switch-on or switch-off signal to the energy generator in form of the respective control signal S_{c} by a time delay. The time delay can advantageously be generated by a random generator 36 so that the time interval used for the control of a plurality of energy generators by means of different electric devices adopts different values. The object of this is that, even with a plurality of electric energy generators, which can be controlled in a way corresponding to each other, no abrupt changes in loads in the electric energy supply grid occur due to a simultaneous increase or reduction or even the simultaneous switching-on or switching-off of all electric energy generators. The randomly specified time delay instead causes the electric energy generators to be controlled gradually with a certain time stagger so that the energy supply grid can be gradually adapted to the changed feed-in situation in each case.

In this case, the random generator 36 can, for example, be designed to determine the time delay directly and specify it to the delay element 35. In this case, the random generator 36 can be set up such that the greater the value by which the respective threshold is exceeded, the shorter the time delay. In this way, in the case of a large surplus or shortage of electric energy, it is possible to control a large number of electric energy generators comparatively quickly.

Alternatively, it can also be provided that the random generator 36 repeatedly generates a random signal, which can adopt at least two different states. If this random signal adopts one selected state, the time-delay process is terminated and the control signal S_{c} is sent immediately to the energy generator. If, on the other hand, the random signal adopts another state, the time-delay process is continued until, after a time interval in which no random signal is generated, the random generator 36 performs a new determination of the random signal.

With this variant, the probability with which the random signal adopts the selected state can be adapted to the degree by which the threshold is exceeded. If is it only slightly exceeded, there is a lower probability of the random generator generating the output random signal with the selected state, while, if the threshold is exceeded to a greater degree requiring a correspondingly quickly countermeasure by controlling the energy generator, there is an increased probability of the random signal adopting the selected state. The probability of the different states of the random signal can also be regulated by increasing the timing frequency with which the random signal is generated. The shorter the intervals between the individual generation times of the random signal are selected, the higher the probability of the selected state being reached in a shorter time so that the time delay used for the delay of the control signal is correspondingly shortened.

It can also be provided that, if, during the time-delay process, the monitored grid parameters fall below the upper threshold (i.e. at the end of the surplus of electric energy) or the grid parameters increase above the lower threshold (i.e. the shortage of electric energy is finished), the time-delay process is interrupted without the control signal being sent to the energy generator. This has the effect that, in the case of a surplus or shortage of electric energy in the energy supply grid, only those electric energy generators that are required to balance the lack of equilibrium in the energy supply grid have to be controlled.

Although the explanation with respect to FIG. 3 includes the functions added compared to FIG. 2 entailing the use of priority levels and priority classes on the one hand and the use of a delay element on the other in a common exemplary embodiment, they can also be provided individually to expand the electric device 13a according to FIG. 2.

The mode of operation of the electric devices described in particular also achieves the advantage that, unlike the case with other centrally controlled systems for optimizing the operation of an energy supply grid, it does not take into consideration the situation of the entire energy supply grid; instead the grid optimization is performed with reference to the specific local energy supply, for example taking into account the effects of nearby large-scale consumers and nearby further energy generators. In this way, transmission losses within the energy supply grid are minimized. In addition to simplifying the entire system (and hence reduced costs), dispensing with communication devices for specifying command controls to the electric devices by means of a central device also achieves the advantage that the grid control is less susceptible to manipulations by so-called cyber attacks, in which hackers attempt to gain access to control systems in the electric energy supply grid in order to bring about instability of the energy supply grid.

1-12. (canceled)

13. An electric device for controlling an electric energy generator that is connected to an electric medium-voltage or low-voltage energy supply grid, comprising
a supply grid-side connection connecting the electric device to a node between the medium-voltage or low-voltage energy supply grid and the energy generator;
a control device for controlling the energy generator with respect to an operating state thereof;
said control device including a monitoring device configured to monitor a voltage and/or a frequency applied to the electric device on a supply grid-side, to generate a switch-on signal when the monitored voltage and/or frequency falls below a lower threshold, and to generate a switch-off signal when the monitored voltage and/or frequency exceeds an upper threshold; and
said control device being configured:
if the switch-on signal is present, to switch on the energy generator or to increase an electric power output by the energy generator to the medium-voltage or low-voltage energy supply grid; and
if the switch-off signal is present, to switch off the energy generator or to decrease the electric power output by the energy generator to the medium-voltage or low-voltage energy supply grid.

14. The electric device according to claim 13, wherein the energy generator comprises an energy storage device and said control device is configured, if the switch-off signal is present, to decrease the electric power output by the energy generator to the medium-voltage or low-voltage energy supply grid, by partially or wholly diverting the electric energy generated by the energy generator or a primary energy used by the energy generator to generate the electric energy into the energy storage device.

15. The electric device according to claim 14, wherein said control device is configured, if the switch-on signal is present, to increase the electric power output by the energy generator to the medium-voltage or low-voltage energy supply grid by partially or wholly outputting the electric energy stored in the energy storage device to the medium-voltage or low-voltage energy supply grid or to partially or wholly use the primary energy stored in the energy storage device to generate electric energy.

16. The electric device according to claim 13, wherein:
said control device includes a a random generator and a delay element, which is configured:
if a switch-on signal is present, to delay a switching-on of the energy generator or an increase of the power output by the energy generator by a time delay specified by said random generator; and
if a switch-off signal is present, to delay a switching-off of the energy generator or a decrease of the power output by the energy generator by a time delay specified by said random generator.

17. The electric device according to claim 16, wherein said random generator is configured to output the time delay directly.

18. The electric device according to claim 17, wherein said random generator is configured for define a shorter time delay the more a value of the monitored voltage and/or frequency exceeds the upper threshold or falls below the lower threshold.

19. The electric device according to claim 16, wherein said random generator is configured to output a random signal with at least two states, and wherein, when a selected state of the random signal is present, the time-delay process is terminated, while, if the selected state is absent, the time-delay process is continued and the random signal is generated again.

20. The electric device according to claim 19, wherein said the random generator is configured to increase a probability with which the random signal adopts the selected state the more the value of the monitored voltage and/or frequency exceeds the upper threshold or falls below the lower threshold.

21. The electric device according to claim 20, wherein said random generator is configured to output sequential random signals and to output the random signal with a shorter time interval between two sequential outputs the more the value of the monitored voltage and/or frequency exceeds the upper threshold or falls below the lower threshold.

22. The electric device according to claim 16, wherein said delay element is configured to cancel a time-delay process, if the monitored voltage and/or frequency falls below the upper threshold or exceeds the lower threshold during the time delay.

23. The electric device according to claim 13, wherein:
the electric device is assigned a priority class in dependence on a type of energy generator and information on the priority class is stored in a storage device of the electric device; and
the energy generator is only controlled by the electric device if the information on the priority class conforms to a priority level determined by said control device in dependence on a degree to which a value of the monitored voltage and/or frequency exceeds the upper threshold or falls below the lower threshold.

24. A method of operating an electric medium-voltage or low-voltage energy supply grid, the method comprising:
at least one energy generator connected to the medium-voltage or low-voltage energy supply grid for supplying electric power into the medium-voltage or low-voltage energy supply grid;
monitoring with an electric device a voltage and/or frequency present at a node connecting the energy generator and the medium-voltage or low-voltage energy supply grid on a grid side; and
if the monitored voltage and/or frequency falls below a lower threshold, switching on the energy generator or increasing the electric power output by the energy generator to the medium-voltage or low-voltage energy supply grid; and
if the monitored voltage and/or frequency exceeds an upper threshold, switching off the energy generator or decreasing the electric power output by the energy generator to the medium-voltage or low-voltage energy supply grid.
